(19) United States
(12) Patent Application Publication
(10) Pub. No.: US 2018/0173382 A1
(43) Pub. Date: Jun. 21, 2018

(54) DISPLAY APPARATUS FOR PROVIDING USER INTERFACE AND CONTROLLING METHOD THEREOF

(71) Applicant: SAMSUNG ELECTRONICS CO., LTD., Suwon-si (KR)

(72) Inventors: Sul Hee YANG, Seoul (KR); Jang Won SEO, Seoul (KR)

(73) Assignee: SAMSUNG ELECTRONICS CO., LTD., Suwon-si (KR)

(21) Appl. No.: 15/844,016

(22) Filed: Dec. 15, 2017

(30) Foreign Application Priority Data
Dec. 16, 2016 (KR) 10-2016-0172672

(51) Int. Cl. G06F 3/0482

(52) U.S. Cl. CPC G06F 3/0482; G06F 2203/04804

(57) ABSTRACT

A display apparatus includes a display, an input module receiving a user input, a processor is configured to display a user interface (UI) including a first object and a second object on the display, receives a user input to select the second object when the first object is selected as a currently selected object, select the second object as the currently selected object based on the received user input in a first direction and display a third object corresponding to the selected second object on the display. The processor is configured to move the third object in a second direction when the second object is selected as the currently selected object in the first direction.

### CROSS-REFERENCE TO RELATED APPLICATION(S)

This application claims the benefit under 35 U.S.C. § 119(a) of a Korean patent application filed on Dec. 16, 2016 in the Korean Intellectual Property Office and assigned Serial number 10-2016-0172672, the entire disclosure of which is hereby incorporated by reference.

### TECHNICAL FIELD

The present disclosure relates to a display apparatus that provides a user interface (UI) including information about a change direction of the selected object, and a controlling method of the display apparatus.

### BACKGROUND

A display apparatus is providing contents and functions for convenience of a user. The display apparatus may receive the user input to display the contents in a display or to execute the function, from the user through a remote control apparatus.

The display apparatus is providing various contents and functions to the user while developing into the form of a smart television (TV). As such, the display apparatus may display the UI associated with a plurality of contents and functions, in the display and may receive a user input for displaying contents in a display or executing a function, from the user through UI.

The display apparatus may divide menus of the UI for displaying various contents and functions to be provided to the user in a limited display, into a plurality of layers; and when a menu is selected, the display apparatus may display contents and functions corresponding to the selected menu in the UI.

### SUMMARY

A display apparatus may display a UI for displaying contents and functions, which are provided to a user by using a plurality of objects, in a display. If receiving a user input for selecting one object of the plurality of objects, the display apparatus may change the selected object from one object to another object. If displaying an image or the like corresponding to an object selected simply in a display, the display apparatus may provide only limited information through the UI to provide the user with only a limited user experience (UX).

Aspects of the present disclosure are to address at least the above-mentioned problems and/or disadvantages and to provide at least the advantages described below. Accordingly, an aspect of the present disclosure is to provide a display apparatus that provides a user with a UI including information about a direction for changing the selected object, when an object corresponding to a user input is selected, and a controlling method of the display apparatus.

In accordance with an aspect of the present disclosure, a display apparatus includes a display, an input module configured to receive a user input, a processor configured to display a user interface (UI) including a first object and a second object on the display, receive the user input from the input module to select the second object when the first object is selected as a currently selected object, select the second object as the currently selected object based on the received user input in a first direction facing the second object from the first object, display a third object corresponding to the selected second object on the display, and move the third object in a second direction based on the first direction.

In accordance with an aspect of the present disclosure, a controlling method of a display apparatus includes displaying a UI including a first object and a second object on a display, receiving a user input to select the second object when the first object is selected as a currently selected object, selecting the second object as the currently selected object based on the received user input in a first direction facing the second object from the first object, displaying a third object corresponding to the selected second object on the display, and moving the third object in a second direction based on the first direction.

Other aspects, advantages, and salient features of the disclosure will become apparent to those skilled in the art from the following detailed description, which, taken in conjunction with the annexed drawings, discloses various embodiments of the present disclosure.

According to an embodiment of the present disclosure, when an object corresponding to a user input is selected, a display apparatus providing a UI and a controlling method of the display apparatus may move an object corresponding to the selected object to provide a user with information about a direction for changing the selected object, thereby notifying the user of the direction for changing the selected object.

Besides, a variety of effects directly or indirectly understood through this disclosure may be provided.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a display system according to various embodiments of the present disclosure;

FIG. 2 is a block diagram illustrating a configuration of a display apparatus, according to various embodiments of the present invention;

FIGS. 3A to 3C are views illustrating how a sub-menu is displayed in a display apparatus, according to an embodiment of the present disclosure;

FIGS. 4A to 4C are views illustrating how a sub-menu is displayed in a display apparatus, according to an embodiment of the present disclosure;

FIGS. 5A to 5C are views illustrating how information about an object is displayed in a display apparatus, according to an embodiment of the present disclosure;

FIGS. 6A to 6C are views illustrating how a content image is displayed in a display apparatus, according to an embodiment of the present disclosure; and

FIG. 7 is a flowchart illustrating a control method of a display apparatus, according to an embodiment of the present disclosure.

Throughout the drawings, it should be noted that like reference numbers are used to depict the same or similar elements, features, and structures.

### DETAILED DESCRIPTION

Hereinafter, various embodiments of the present invention may be described with reference to accompanying drawings. Accordingly, those of ordinary skill in the art will recognize that modification, equivalent, and/or alternative on the various embodiments described herein can be variously made without departing from the scope and spirit of the present invention. With regard to description of drawings, similar elements may be marked by similar reference numerals.

In this disclosure, the expressions “have”, “may have”, “include” and “comprise”, or “may include” and “may comprise” used herein indicate existence of corresponding features (e.g., elements such as numeric values, functions, operations, or components) but do not exclude presence of additional features.

In this disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used in this disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in this disclosure are used to describe specified embodiments and are not intended to limit the scope of the present invention. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of this disclosure. In some cases, even if terms are terms which are defined in this disclosure, they may not be interpreted to exclude embodiments of this disclosure.

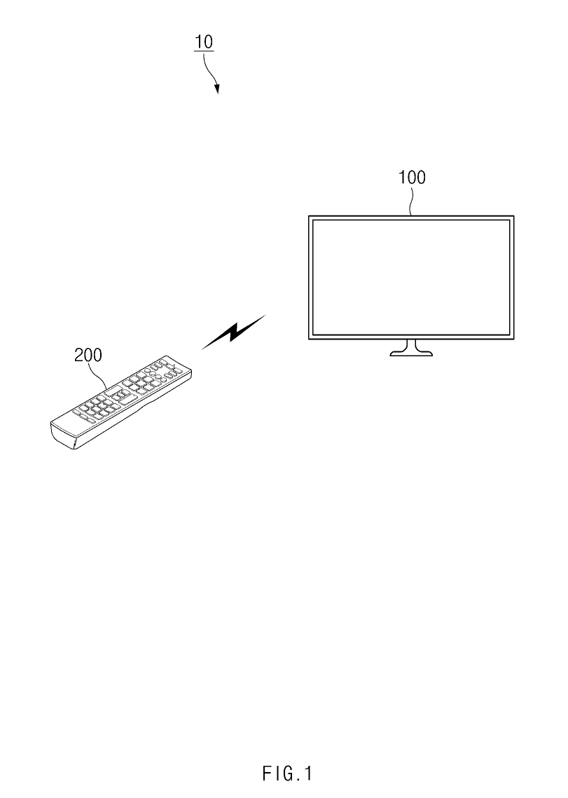

FIG. 1 is a view illustrating a display system according to various embodiments of the present disclosure.

Referring to FIG. 1, a display system 10 may include a display apparatus 100 and a remote control apparatus 200.

The display apparatus 100 may display an image in a display. For example, the display apparatus 100 may display an image (e.g., a video image) stored in a memory of the display apparatus 100, in the display. For another example, the display apparatus 100 may be connected with a source apparatus through a wired communication interface (e.g., a high definition multimedia interface (HDMI), digital video/visual interactive (DVI), video graphics array (VGA), or the like) or a wireless communication interface (e.g., Bluetooth, near field communication (NFC), wireless-fidelity (Wi-Fi), or the like) to receive content including an image and may display the received image in the display.

According to an embodiment, the display apparatus 100 may be implemented with various apparatuses, which are able to display an image, such as a TV, a desktop, a notebook PC, a smartphone, a tablet PC, a monitor, an electronic frame, and the like.

According to an embodiment, the display apparatus 100 may display a user interface (UI) including a plurality of objects (e.g., an icon, an item, and the like) in the display. For example, the display apparatus 100 may receive a user input from the remote control apparatus 200 and may select an object corresponding to the user input among of the plurality of objects. For example, the user input to select the object may be an input for changing to a state to display an image corresponding to the selected object in the display. The display apparatus 100 may receive another user input (e.g., confirmation) to display the image or the like in the display. For another example, the user input to select the object may be an input that allows an image or the like corresponding to the selected object to be displayed in the display.

The remote control apparatus 200 may transmit the user input (e.g., a control signal corresponding to the user input) to the display apparatus 100. The remote control apparatus 200 may communicate with the display apparatus 100 through a short range wireless communication interface such as a Bluetooth, NFC, or an infrared (IR) transceiver. According to an embodiment, the remote control apparatus 200 may include at least one button, a touch panel, a motion recognition sensor, or a speech recognition sensor, which is used for the user to input a command.

According to an embodiment, the remote control apparatus 200 may transmit a user input to select an object of a UI displayed in the display apparatus 100 to the display apparatus 100. The user may enter a command to select an object of the UI displayed in the display apparatus 100 through the remote control apparatus 200. The display apparatus 100 may select an object corresponding to the received user input.

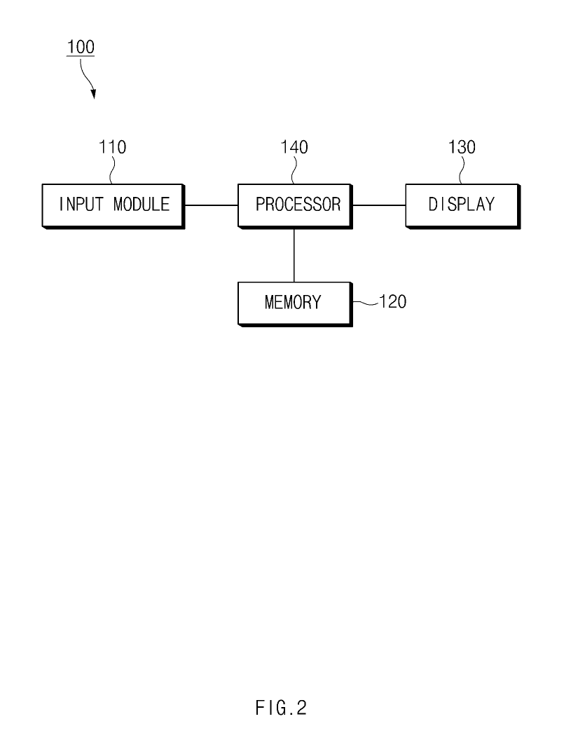

FIG. 2 is a block diagram illustrating a configuration of a display apparatus, according to various embodiments of the present invention.

Referring to FIG. 2, the display apparatus 100 may include an input module 110, a memory 120, a display 130, and a processor 140.

The input module 110 may receive a user input for controlling the display apparatus 100. For example, the input module 110 may include a communication module (e.g., a wireless communication module and a wired communication module) and may receive a user input from an input apparatus, such as the remote control apparatus 200, a keyboard, a mouse, or the like, through the communication module. For another example, the input module 110 may include the input apparatus (e.g., a button or the like) directly installed in the display apparatus 100 and may receive a user input through the input apparatus. According to an embodiment, the input module 110 may transmit the received user input to the processor 140.

The memory 120 may store content image information to be displayed in the display 130. A content image included in the content image information stored in the memory 120 may be displayed in the display 130 so as to be provided to a user.

According to an embodiment, the memory 120 may store a UI including a plurality of objects. For example, the memory 120 may store a UI including a plurality of objects each of which is implemented with at least one of a text, an image, and an icon (or an item).

The display 130 may display a content image. For example, the display 130 may display the content image stored in the memory 120. For another example, the display 130 may display an image received from a source apparatus. According to an embodiment, the display 130 may display a UI (or a UI image). The display 130 may display the content image and the UI at the same time.

The processor 140 may control overall operations of the display apparatus 100. For example, the processor 140 may receive a user input from the input module 110. The processor 140 may display a content image and a UI in the display 130 by using information stored in the memory 120.

According to an embodiment, the processor 140 may receive the user input to select an object corresponding to the user input. According to an embodiment, the processor 140 may receive the user input to change the selected object. For example, the processor 140 may change the selected object from a first object to a second object depending on the user input. In other words, the processor 140 may receive the user input in a state where the first object is selected (e.g. as a currently selected object), and may change the state to a state where the second object is selected. For example, when displaying a UI 320 in the display 130, the processor 140 may select the first object (e.g. as a currently selected object). For another example, the processor 140 may select the user input to select the first object.

According to an embodiment, the processor 140 may display the selected object so as to be distinguished from the remaining unselected object(s). For example, the display apparatus 100 may change (e.g., scale) and display the size of the selected object. Also, if there is a way to distinguish the selected object from other unselected items, the processor 140 may use any method (e.g., highlight).

According to an embodiment, the processor 140 may display the object corresponding to the selected object in the display 130. For example, the processor 140 may display a sub-menu corresponding to the selected object in the display 130. The processor 140 may receive the user input to select an object corresponding to the user input among sub-menus included in a UI. For another example, the display apparatus 100 may display information (e.g., content information) corresponding to the selected object in the display 130. For example, the content information included in the UI may include at least one of a text and an image. For another example, the display apparatus 100 may display a content image corresponding to the selected object in the display 130.

According to an embodiment, when changing the selected object, the processor 140 may display an object corresponding to the selected object in the display 130, and may move the object displayed in the display 130, based on a direction in which the selected object is changed. For example, when changing the selected object from a first object to a second object, the processor 140 may display a third object corresponding to the second object in the display 130, and may move the third object in a second direction based on a first direction facing the second object from the first object. For example, the second direction may be a direction (e.g., an opposite direction) different from the first direction. For another example, the second direction may be the same direction as the first direction. In other words, the processor 140 may display the third object at a second location, to which the third object is moved by a specified distance in the second direction from a first location set to the third object, and may move the third object from the second location to the first location.

According to an embodiment, when moving the object displayed in the display 130, the processor 140 may change transparency. For example, when moving the third object, the processor 140 may gradually decrease the transparency of the third object. For example, the processor 140 may start the movement in a state (e.g., a transparency value=100) where the third object is transparent, may move the third object in a state (e.g., the transparency value=1˜99) where the third object is translucent, and may complete the movement in a state (e.g., the transparency value=0) where the third object is opaque.

As such, when the selected object is changed, the display apparatus 100 may provide information about a direction according to the change in the selected object, by moving an object corresponding to the selected object based on the changed direction.

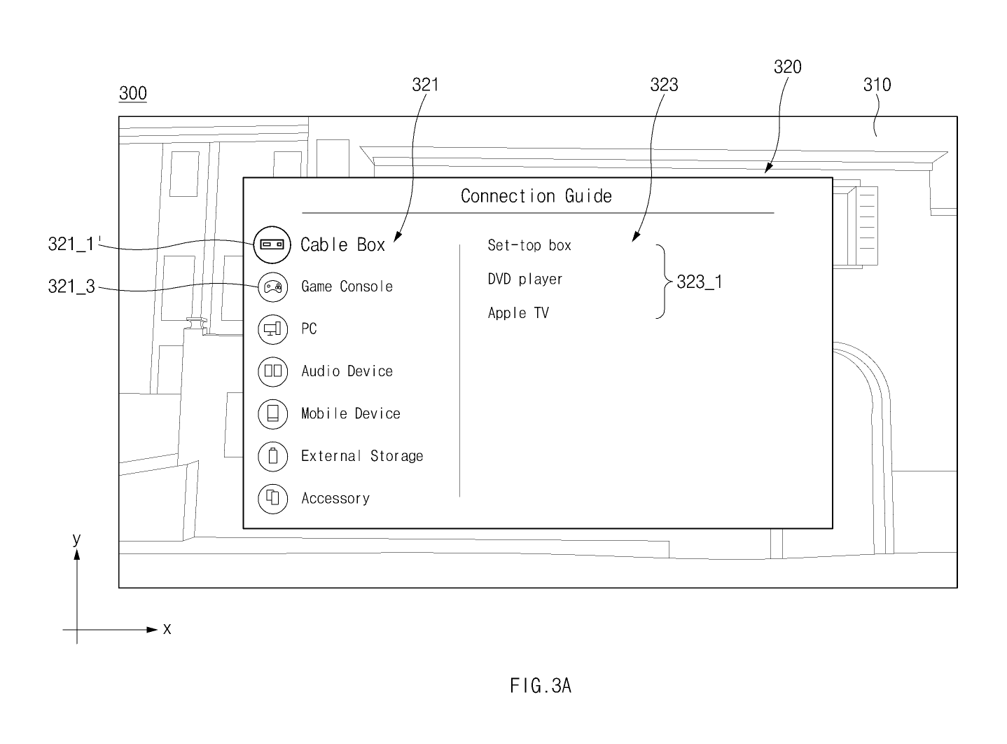

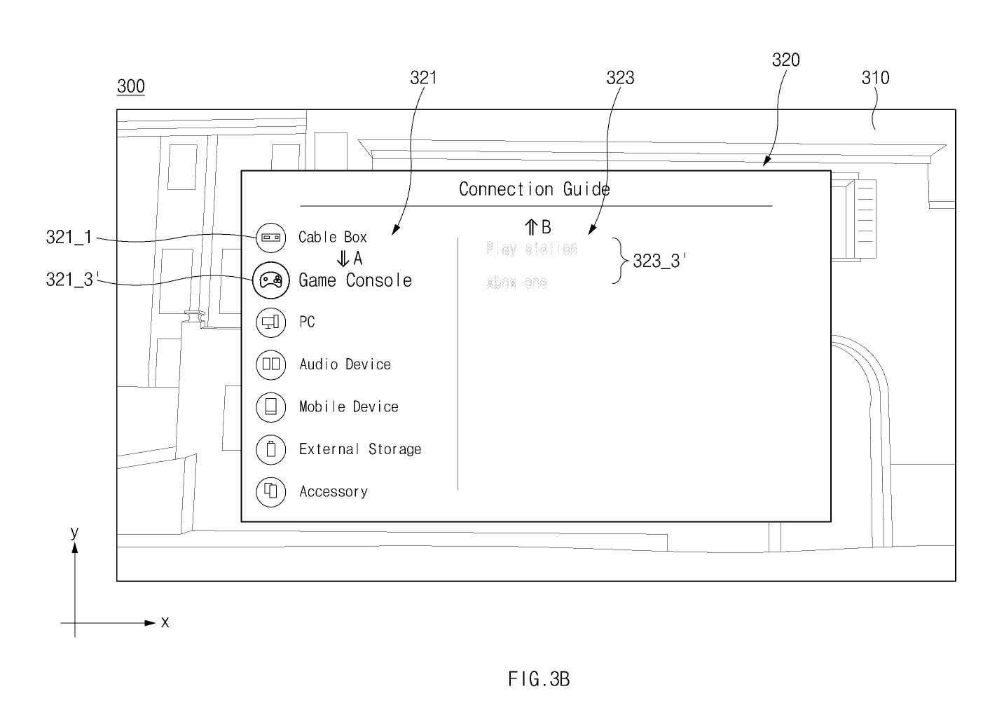

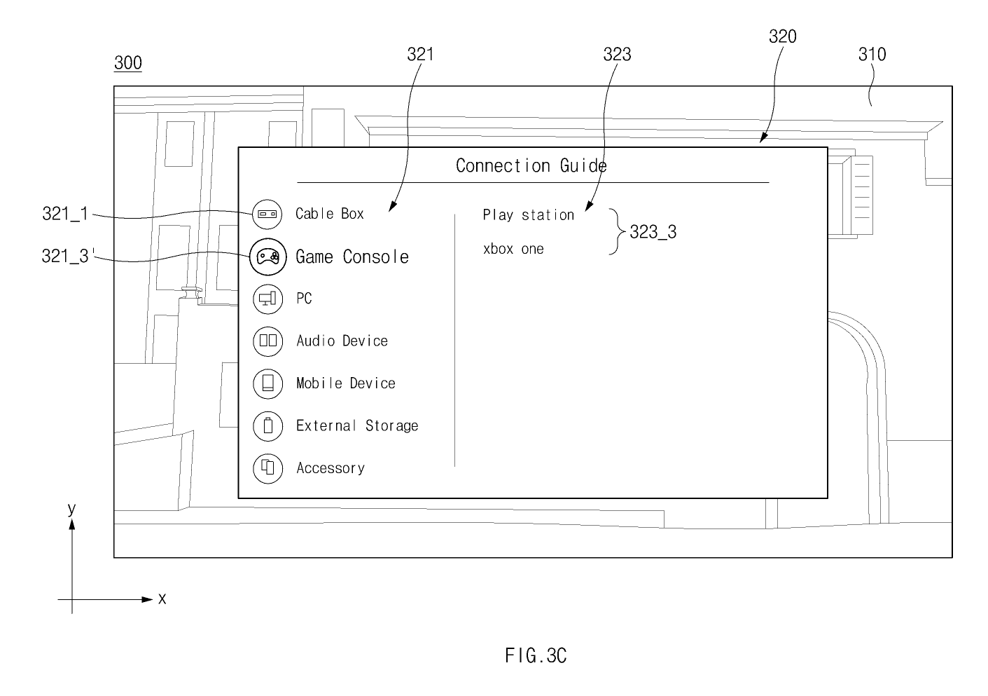

FIGS. 3A to 3C are views illustrating how a sub-menu is displayed in a display apparatus, according to an embodiment of the present disclosure.

Referring to FIGS. 3A to 3C, the display apparatus 100 may display at least one of a content image 310 and a UI 320 in the display 130. In other words, a screen 300 displayed in the display 130 may include at least one of the content image 310 and the UI 320.

According to an embodiment, the display apparatus 100 may receive a user input to change the selected object in a direction (or a vertical direction) parallel to y axis with respect to x-y axis illustrated in FIGS. 3A to 3C.

Referring to FIG. 3A, the display apparatus 100 may display the UI 320 including a plurality of objects selectable depending on a user input, in the display 130. For example, the display apparatus 100 may display objects corresponding to the connected devices in the UI 320. For example, the UI 320 may include a first menu 321 and a second menu 323. The first menu 321 may include an object (or a selection menu) indicating a type of a connected device, and the second menu 323 may include an object (or a sub-menu) indicating a connected device corresponding to a type of the selected connected device.

According to an embodiment, the display apparatus 100 may select a first object 321_1′ of the first menu 321 depending on the user input. The display apparatus 100 may enlarge the size of the first object 321_1′ to display the enlarged first object 321_1′, or may display the first object 321_1′ so as to be distinguished from an unselected second object 321_3 of the first menu 321.

According to an embodiment, the display apparatus 100 may display a third object 323_1 corresponding to the selected first object 321_1′ in the display 130. The third object 323_1 may be included in the second menu 323 and may be a sub-menu of the first object 321_1′.

Referring to FIG. 3B, the display apparatus 100 may receive a user input to change the selected object from a first object 321_1 to a second object 321_3′.

According to an embodiment, the display apparatus 100 may receive a user input to select the second object 321_3′ (e.g. as a currently selected object). For example, the display apparatus 100 may receive a user input (e.g., a user input entered through a direction key of a vertical direction) to move in a direction (direction A) (or a first direction) of the second object 321_3′ from the first object 321_1.

According to an embodiment, the display apparatus 100 may change the selected object from the first object 321_1 to the second object 321_3′ depending on the user input. The display apparatus 100 may reduce the size of the first object 321_1 and may enlarge the size of the second object 321_3′. For example, the display apparatus 100 may gradually reduce the size of the first object 321_1 during a specified time and may gradually enlarge the size of the second object 321_3′ during the specified time.

According to an embodiment, the display apparatus 100 may display a fourth object 323_3′ corresponding to the second object 321_3′ selected by the user input, in the display 130. The fourth object 323_3′ may be included in the second menu 323 and may be the sub-menu of the second object 321_3′. For example, the display apparatus 100 may set the transparency of the fourth object 323_3′ to be high (e.g., the transparency value=100). According to an embodiment, the display apparatus 100 may move the fourth object 323_3′ displayed in the display 130, in a direction (direction B) (or a second direction), which is opposite to a direction of the second object 321_3′, from the first object 321_1. For example, the display apparatus 100 may move the fourth object 323_3′ during a specified time when the size of the second object 321_3′ is gradually enlarged (or during a specified time when the size of the first object 321_1 is gradually reduced). According to an embodiment, when moving the fourth object 323_3′, the display apparatus 100 may change the transparency of the fourth object 323_3′. For example, the display apparatus 100 may gradually decrease the transparency of the fourth object 323_3′.

Referring to FIG. 3C, the display apparatus 100 may select the second object 321_3′ depending on the received user input.

According to an embodiment, the display apparatus 100 may select the second object 321_3′ (e.g. as a currently selected object) depending on the user input (e.g. in the first direction facing the second object from the first object). The display apparatus 100 may enlarge the size of the second object 321_3′ and may display the second object 321_3′ so as to be distinguished from the unselected first object 321_1.

According to an embodiment, the display apparatus 100 may display a fourth object 323_3 corresponding to the selected the second object 321_3′ in the display 130. For example, the display apparatus 100 may complete the movement of the fourth object 323_3 and may set the transparency of the fourth object 323_3 to be lower (e.g., a transparency value=0).

According to an embodiment, the display apparatus 100 may change the selected object from the second object 321_3′ to the first object 321_1. As opposed to details described in FIGS. 3A to 3C, the display apparatus 100 may enlarge the first object 321_1, may reduce the second object 321_3′, and may display a third object corresponding to the first object 321_1 in the display 130. The display apparatus 100 may move the third object 323_1′ in a direction, which is opposite to a direction of the first object 321_1, from the second object 321_3′.

As another embodiment, when changing the selected object from the first object 321_1 to the second object 321_3′, the display apparatus 100 may move the third object in the direction of the second object 321_3 from the first object 321_1′. In other words, the display apparatus 100 may move an object corresponding to the newly selected object in the same direction as a direction in which the selected object is changed.

As such, when changing the selected object from a first object to a second object in a vertical direction, the display apparatus 100 may move a sub-menu corresponding to the second object in a direction, which is opposite to a direction of the second object, from the first object to notify a user of a direction in which an object is selected.

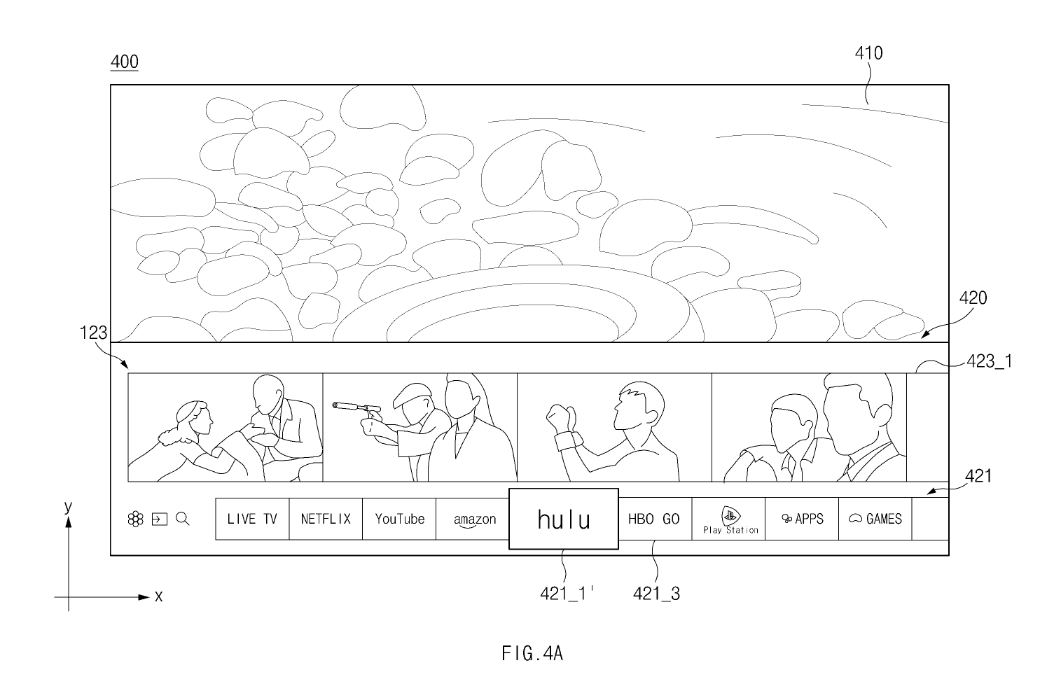

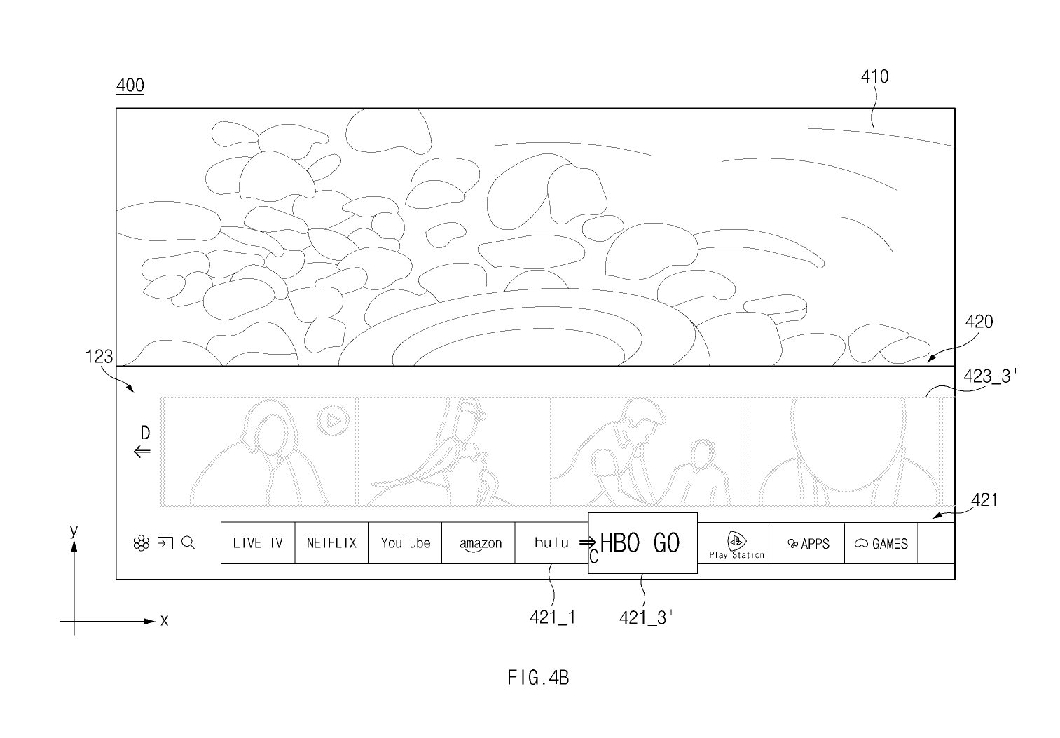

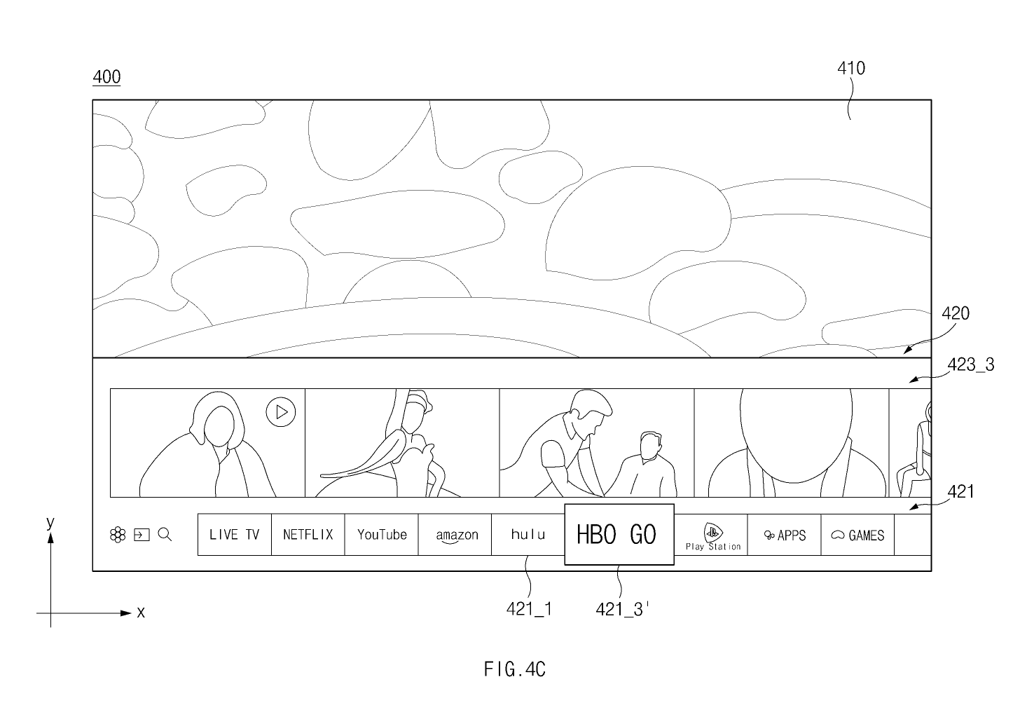

FIGS. 4A to 4C are views illustrating how a sub-object is displayed in a display apparatus, according to an embodiment of the present disclosure.

Referring to FIGS. 4A to 4C, the display apparatus 100 may display at least one of a content image 410 and a UI 420 in the display 130. In other words, a screen 400 displayed in the display 130 may include at least one of the content image 410 and the UI 420.

According to an embodiment, the display apparatus 100 may receive a user input to change the selected object in a direction (or a horizontal direction) parallel to x axis with respect to x-y axis illustrated in FIGS. 4A to 4C.

Referring to FIG. 4A, the display apparatus 100 may display the UI 420 including a plurality of objects selectable depending on a user input, in the display 130. For example, the display apparatus 100 may display an object corresponding to a content image (e.g., a content video image) in the display 130. For example, the UI 420 may include a first menu 421 and a second menu. The first menu 421 may include an object (e.g., a selection menu) indicating a channel including contents, and the second menu may include an object (or a sub-menu) indicating contents corresponding to the selected channel.

According to an embodiment, the display apparatus 100 may select a first object 421_1′ of the first menu 421 depending on the user input. The display apparatus 100 may enlarge the size of the first object 421_1′ to display the enlarged first object 421_1′, or may display the first object 421_1′ so as to be distinguished from an unselected second object 421_3 of the first menu 421.

According to an embodiment, the display apparatus 100 may display a third object 423_1 corresponding to the selected first object 421_1′ in the display 130. The third object 423_1 may be included in the second menu 423 and may be a sub-menu of the first object 421_1′.

Referring to FIG. 4B, the display apparatus 100 may receive a user input to change the selected object from a first object 421_1 to a second object 421_3′.

According to an embodiment, the display apparatus 100 may receive a user input to select the second object 421_3′. For example, the display apparatus 100 may receive a user input (e.g., a user input entered through a direction key of a horizontal direction) to move in a direction (direction C) (or a first direction) of the second object 421_3′ from the first object 421_1.

According to an embodiment, the display apparatus 100 may change the selected object from the first object 421_1 to the second object 421_3′ depending on the user input. The display apparatus 100 may gradually reduce the size of the first object 421_1 during a specified time and may gradually enlarge the size of the second object 421_3′ during the specified time.

According to an embodiment, the display apparatus 100 may display a fourth object 423_3′ corresponding to the second object 421_3′ selected by the user input, in the display 130. The fourth object 423_3′ may be included in the second menu 423 and may be the sub-menu of the second object 421_3′. For example, the display apparatus 100 may set the transparency of the fourth object 423_3′ to be high (e.g., the transparency value=100). According to an embodiment, the display apparatus 100 may move the fourth object 423_3′ displayed in the display 130, in a direction (direction D) (or a second direction), which is opposite to a direction of the second object 421_3′, from the first object 421_1. For example, the display apparatus 100 may move the fourth object 423_3′ during a specified time when the size of the second object 421_3′ is gradually enlarged (or during a specified time when the size of the first object 421_1 is gradually reduced). According to an embodiment, when moving the fourth object 423_3′, the display apparatus 100 may change the transparency of the fourth object 423_3′. For example, the display apparatus 100 may gradually decrease the transparency of the fourth object 423_3′.

Referring to FIG. 4C, the display apparatus 100 may select the second object 421_3′ depending on the received user input.

According to an embodiment, the display apparatus 100 may select the second object 421_3′ depending on the user input. The display apparatus 100 may enlarge the size of the second object 421_3′ and may display the second object 421_3′ so as to be distinguished from the unselected first object 421_1.

According to an embodiment, the display apparatus 100 may display a fourth object 423_3 corresponding to the selected the second object 421_3′ in the display 130. For example, the display apparatus 100 may complete the movement of the fourth object 423_3 and may set the transparency of the fourth object 423_3 to be lower (e.g., a transparency value=0).

According to an embodiment, the display apparatus 100 may change the selected object from the second object 421_3′ to the first object 421_1. As opposed to details described in FIGS. 4A to 4C, the display apparatus 100 may enlarge the first object 421_1, may reduce the second object 421_3′, and may display a third object′ corresponding to the first object 421_1′ in the display 130. The display apparatus 100 may move the third object 423_1′ in a direction, which is opposite to a direction of the first object 421_1′, from the second object 421_3.

As such, when changing the selected object from a first object to a second object in a horizontal direction, the display apparatus 100 may move a sub-menu corresponding to the second object in a direction, which is opposite to a direction of the second object, from the first object to notify a user of a direction in which an object is selected.

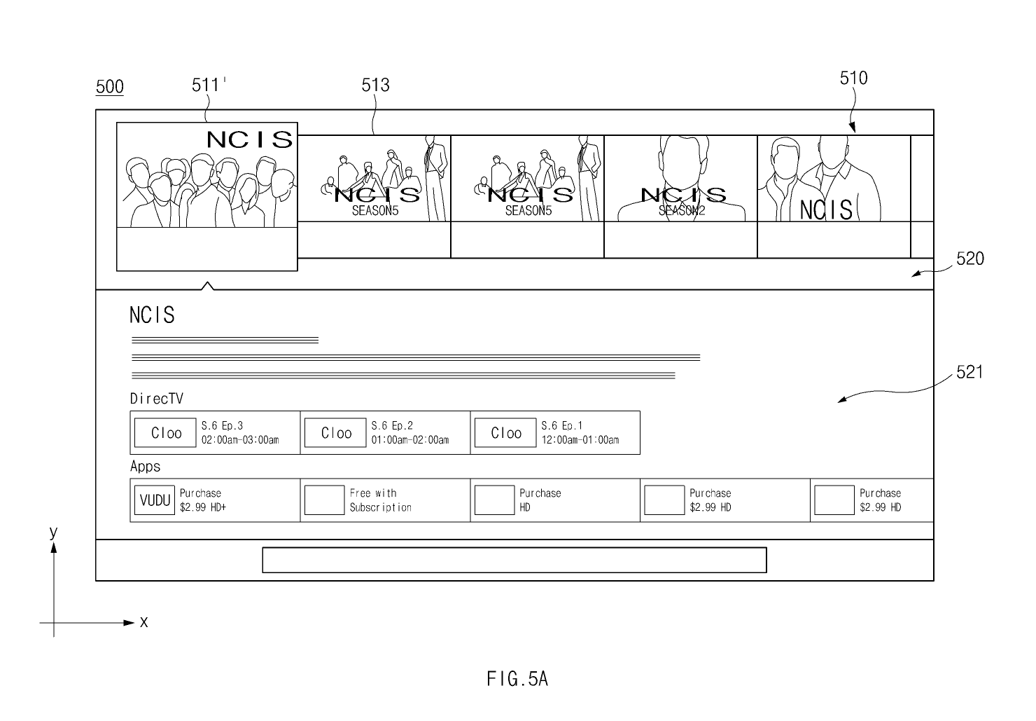

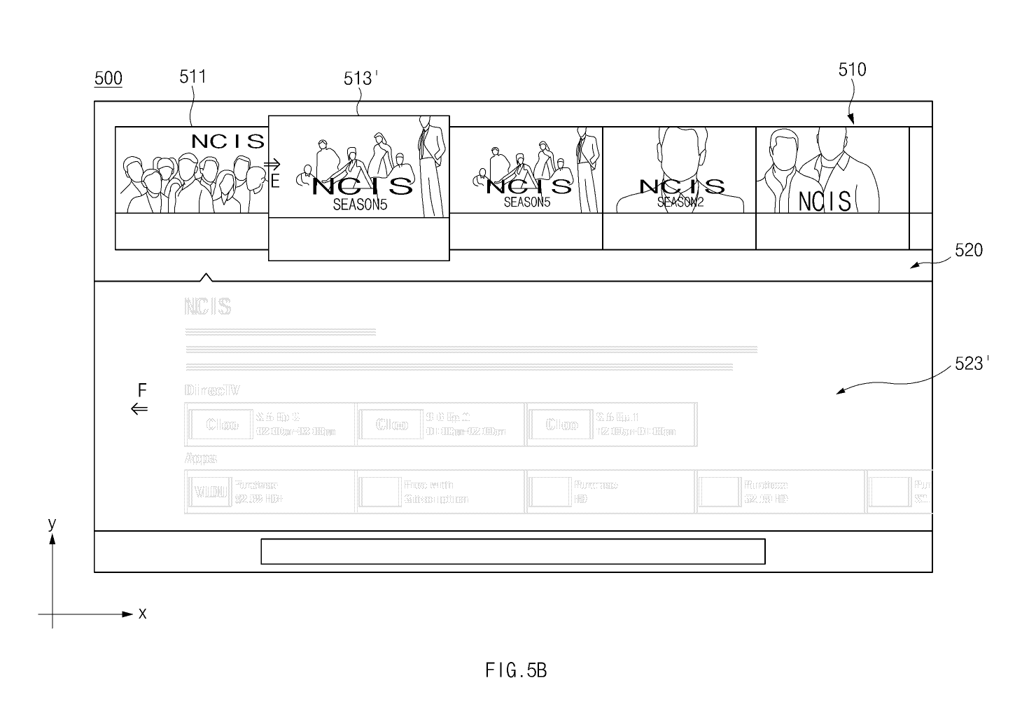

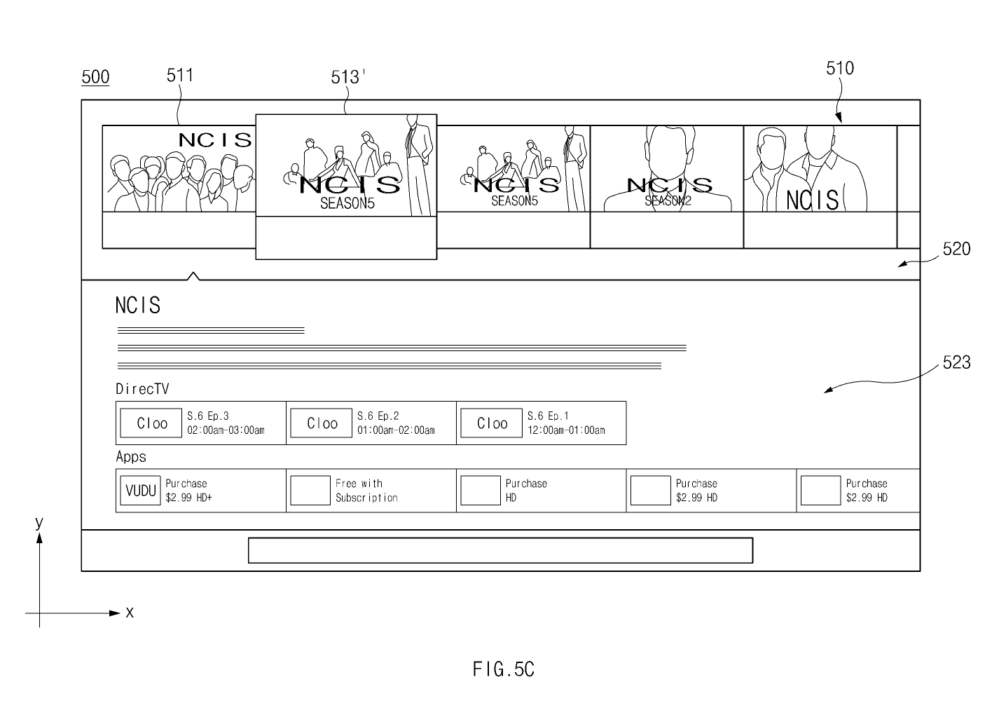

FIGS. 5A to 5C are views illustrating how information about an object is displayed in a display apparatus, according to an embodiment of the present disclosure.

Referring to FIGS. 5A to 5C, the display apparatus 100 may display a UI in the display 130. In other words, a screen 500 displayed in the display 130 may include a UI.

According to an embodiment, the display apparatus 100 may receive a user input to change the selected object in a direction (or a horizontal direction) parallel to x axis with respect to x-y axis illustrated in FIGS. 5A to 5C.

Referring to FIG. 5A, the display apparatus 100 may display a UI including a plurality of selectable objects in the display 130 depending on a user input, and may display information corresponding to the selected object in the display 130. For example, the display apparatus 100 may display an object (or a selection menu) corresponding to contents in the display 130 and may display information (or content information) about the selected object in the display 130. For example, the UI may include a content menu 510 and content information 520.

According to an embodiment, the display apparatus 100 may select a first object 511′ of the content menu 510 depending on the user input. The display apparatus 100 may enlarge the size of the first object 511′ to display the first object 511′, or may display the first object 511′ so as to be distinguished from an unselected second object 513 of the content menu 510.

According to an embodiment, the display apparatus 100 may display a third object 521 corresponding to the selected first object 511′ in the display 130. The third object 521 may be included in the content information 520, and may be information (e.g., content information) about the first object 511′. For example, the information about the first object 511′ may include at least one of a text and an image.

Referring to FIG. 5B, the display apparatus 100 may receive a user input to change the selected object from a first object 511 to a second object 513′.

According to an embodiment, the display apparatus 100 may receive a user input to select the second object 513′. For example, the display apparatus 100 may receive a user input (e.g., a user input entered through a direction key of a horizontal direction) to move in a direction (direction E) (or a first direction) of the second object 513′ from the first object 511.

According to an embodiment, the display apparatus 100 may change the selected object from the first object 511 to the second object 513′ depending on the user input. The display apparatus 100 may gradually reduce the size of the first object 511 during a specified time and may gradually enlarge the size of the second object 513′ during the specified time.

According to an embodiment, the display apparatus 100 may display a fourth object 523′ corresponding to the second object 513′ selected by the user input, in the display 130. The fourth object 523′ may include information about the second object 513′. For example, the information about the second object 513′ may include at least one of a text and an image. For example, the display apparatus 100 may set the transparency of the fourth object 523′ to be high (e.g., the transparency value=100). According to an embodiment, the display apparatus 100 may move the fourth object 523′ displayed in the display 130, in a direction (direction F) (or a second direction), which is opposite to a direction of the second object 513′, from the first object 511. For example, the display apparatus 100 may move the fourth object 523′ during a specified time when the size of the second object 513′ is gradually enlarged (or during a specified time when the size of the first object 511 is gradually reduced). According to an embodiment, when moving the fourth object 523′, the display apparatus 100 may change the transparency of the fourth object 523′. For example, the display apparatus 100 may gradually decrease the transparency of the fourth object 523′.

Referring to FIG. 5C, the display apparatus 100 may select the second object 513′ depending on the received user input.

According to an embodiment, the display apparatus 100 may select the second object 513′ depending on the user input. The display apparatus 100 may enlarge the size of the second object 513′ and may display the second object 513′ so as to be distinguished from the unselected first object 511.

According to an embodiment, the display apparatus 100 may display a fourth object 523 corresponding to the selected second object 513′ in the display 130. For example, the display apparatus 100 may complete the movement of the fourth object 523 and may set the transparency of the fourth object 523 to be lower (e.g., a transparency value=0).

According to an embodiment, the display apparatus 100 may change the selected object from the second object 513′ to the first object 511. As opposed to details described in FIGS. 5A to 5C, the display apparatus 100 may enlarge the first object 511, may reduce the second object 513′, and may display a third object corresponding to the first object 511 in the display 130. The display apparatus 100 may move the third object 521′ in a direction, which is opposite to a direction of the first object 511, from the second object 513′.

As such, when changing the selected object from a first object to a second object in a horizontal direction, the display apparatus 100 may move information about the second object in a direction, which is opposite to a direction of the second object, from the first object to notify a user of a direction in which an object is selected.

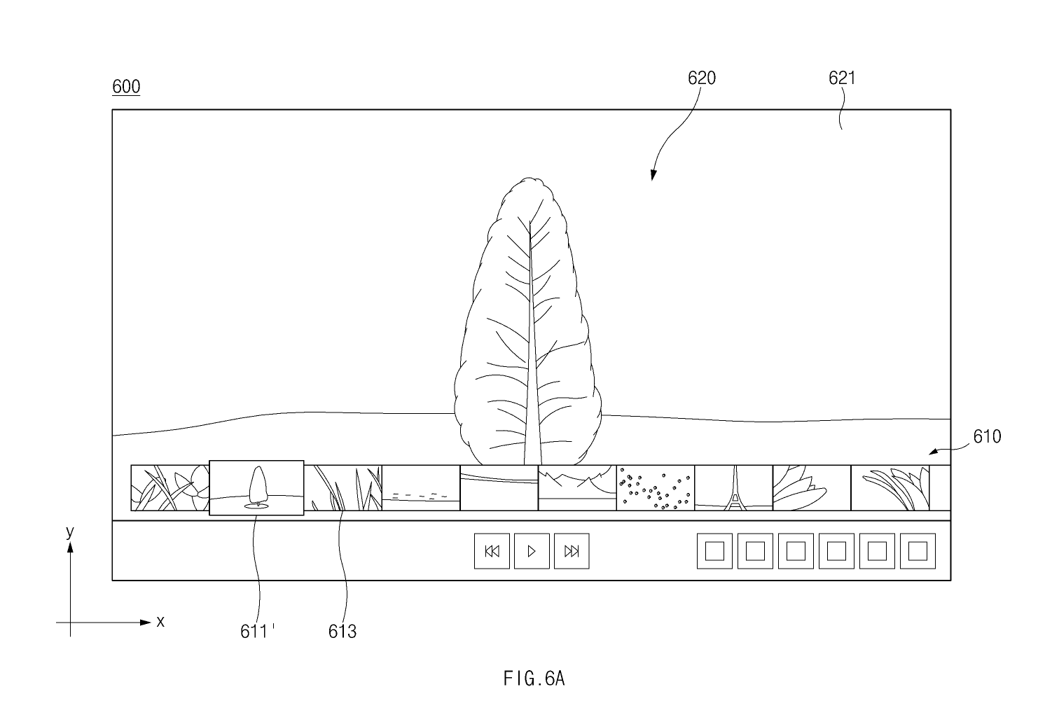

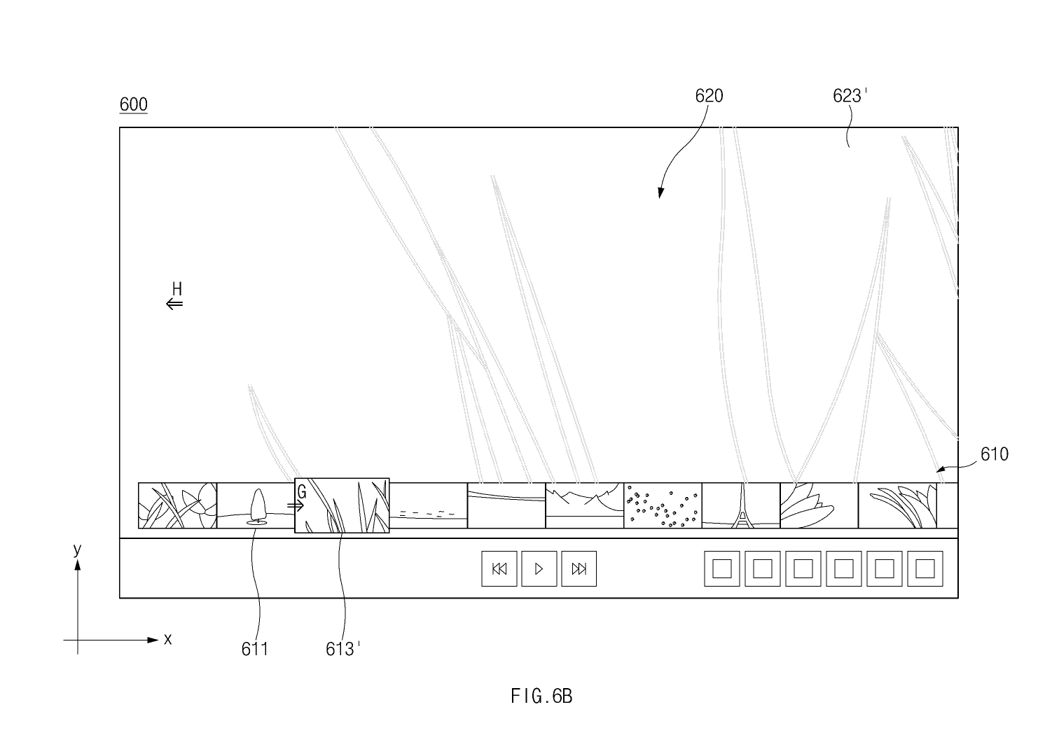

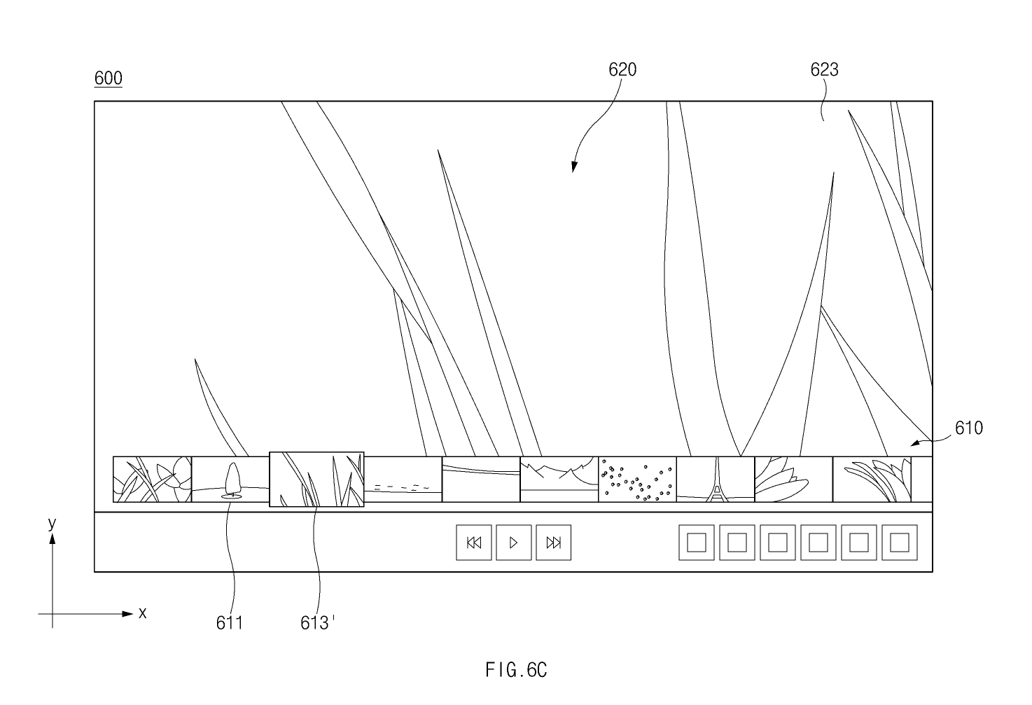

FIGS. 6A to 6C are views illustrating how a content image is displayed in a display apparatus, according to an embodiment of the present disclosure.

Referring to FIGS. 6A to 6C, the display apparatus 100 may display a UI 610 and a content image 620 in the display 130. In other words, a screen 600 displayed in the display 130 may include the UI 610 and the content image 620.

According to an embodiment, the display apparatus 100 may receive a user input to change the selected object in a direction (or a horizontal direction) parallel to x axis with respect to x-y axis illustrated in FIGS. 6A to 6C.

Referring to FIG. 6A, the display apparatus 100 may display a plurality of selectable objects in the display 130 depending on a user input, and may display the content image 620 corresponding to the selected object in the display 130. For example, the display apparatus 100 may display an object (or a content selection menu) corresponding to the content image 620 in the display 130, and may display the content image 620 corresponding to the selected object in the display 130. For example, the UI may include the content menu 610.

According to an embodiment, the display apparatus 100 may select a first object 611′ of the content menu 610 depending on the user input. The display apparatus 100 may enlarge the size of the first object 611′ to display the first object 611′, or may display the first object 611′ so as to be distinguished from an unselected second object 613 of the content menu 610.

According to an embodiment, the display apparatus 100 may display a third object 621 of the content image 620 corresponding to the selected first object 611′ in the display 130. The third object 621 may include a content image corresponding to the first object 611′.

Referring to FIG. 6B, the display apparatus 100 may receive a user input to change the selected object from a first object 611 to a second object 613′.

According to an embodiment, the display apparatus 100 may receive a user input to select the second object 613′. For example, the display apparatus 100 may receive a user input (e.g., a user input entered through a direction key of a horizontal direction) to move in a direction (direction G) (or a first direction) of the second object 613 from the first object 611.

According to an embodiment, the display apparatus 100 may change the selected object from the first object 611 to the second object 613′ depending on the user input. The display apparatus 100 may gradually reduce the size of the first object 611 during a specified time and may gradually enlarge the size of the second object 613′ during the specified time.

According to an embodiment, the display apparatus 100 may display a fourth object 623′ corresponding to the second object 613′ selected by the user input, in the display 130. The fourth object 623′ may include a content image corresponding to the second object 613′. For example, the display apparatus 100 may set the transparency of the fourth object 623′ to be high (e.g., the transparency value=100). According to an embodiment, the display apparatus 100 may move the fourth object 623′ displayed in the display 130, in a direction (direction H) (or a second direction), which is opposite to a direction of the second object 613′, from the first object 611. For example, the display apparatus 100 may move the fourth object 623′ during a specified time when the size of the second object 613′ is gradually enlarged (or during a specified time when the size of the first object 611 is gradually reduced). According to an embodiment, when moving the fourth object 623′, the display apparatus 100 may change the transparency of the fourth object 623′. For example, the display apparatus 100 may gradually decrease the transparency of the fourth object 623′.

Referring to FIG. 6C, the display apparatus 100 may select the second object 613′ depending on the received user input.

According to an embodiment, the display apparatus 100 may display a fourth object 623 corresponding to the selected second object 613′ in the display 130. For example, the display apparatus 100 may complete the movement of the fourth object 623 and may set the transparency of the fourth object 623 to be lower (e.g., a transparency value=0).

According to an embodiment, the display apparatus 100 may change the selected object from the second object 613′ to the first object 611. As opposed to details described in FIGS. 6A to 6C, the display apparatus 100 may enlarge the first object 611, may reduce the second object 613′, and may display a third object corresponding to the first object 611 in the display 130. The display apparatus 100 may move the third object 621′ in a direction, which is opposite to a direction of the first object 611, from the second object 613′.

As such, when changing the selected object from a first object to a second object in a horizontal direction, the display apparatus 100 may move a content image corresponding to the second object in a direction, which is opposite to a direction of the second object, from the first object to notify a user of a direction in which an object is selected.

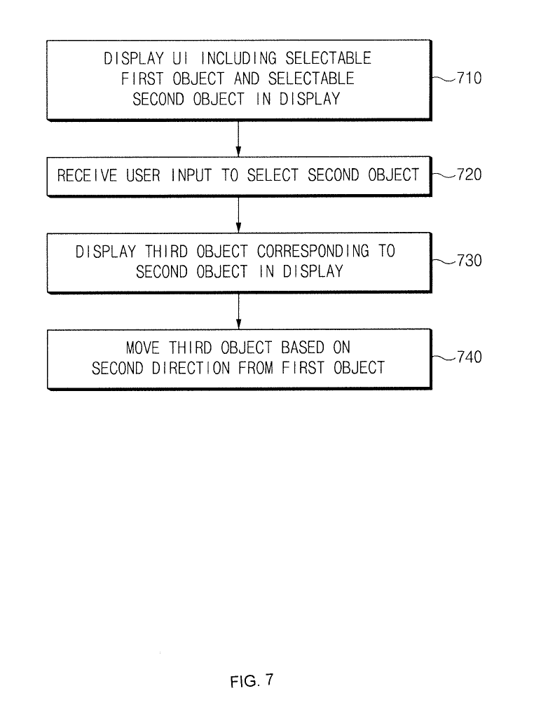

FIG. 7 is a flowchart illustrating a control method of a display apparatus, according to an embodiment of the present disclosure.

The flowchart illustrated in FIG. 7 may include operations processed by the above-described display apparatus 100, and illustrates a controlling method of the display apparatus 100 for displaying a UI including a plurality of objects in the display 130. Although omitted below, the descriptions of the display apparatus 100 given with reference to FIGS. 1 to 6C may be applied to the flowchart illustrated in FIG. 7.

According to an embodiment, in operation 710, the display apparatus 100 may display a UI including a first object and a second object, in the display 130.

According to an embodiment, in operation 720, the display apparatus 100 may receive a user input to select the second object. The display apparatus 100 may change the selected second object to display the changed second object in the display 130. For example, the display apparatus 100 may change the size of the selected second object.

According to an embodiment, in operation 730, the display apparatus 100 may display a third object corresponding to the second object in the display 130. For example, the third object may include a sub-menu corresponding to the second object. For another example, the third object may include information about the second object. For another example, the third object may include a content image corresponding to the second object.

According to an embodiment, in operation 740, the display apparatus 100 may move the third object in a second direction based on a first direction of the second object from the first object. For example, the second direction may be a direction opposite to the first direction. For another example, the second direction may be the same direction as the first direction.

The term “module” used in this disclosure may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor 140 of FIG. 2), may cause the one or more processors to perform a function corresponding to the instruction. The computer-readable storage media, for example, may be the memory (e.g., the memory 120 of FIG. 2).

A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and hardware devices (e.g., a read only memory (ROM), a random access memory (RAM), or a flash memory). Also, a program instruction may include not only a mechanical code such as things generated by a compiler but also a high-level language code executable on a computer using an interpreter. The above hardware unit may be configured to operate via one or more software modules for performing an operation according to various embodiments, and vice versa.

A module or a program module according to various embodiments may include at least one of the above elements, or a part of the above elements may be omitted, or additional other elements may be further included. Operations performed by a module, a program module, or other elements according to various embodiments may be executed sequentially, in parallel, repeatedly, or in a heuristic method. In addition, some operations may be executed in different sequences or may be omitted. Alternatively, other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A display apparatus comprising:
a display;
an input module configured to receive a user input;
a processor configured to:
display a user interface (UI) including a first object and a second object on the display;
receive the user input from the input module to select the second object when the first object is selected as a currently selected object;
select the second object as the currently selected object based on the received user input in a first direction facing the second object from the first object;
display a third object corresponding to the selected second object on the display; and
move the third object in a second direction based on the first direction.

2. The display apparatus of claim 1, wherein the second direction is a direction opposite to the first direction.

3. The display apparatus of claim 1, wherein the second direction is the same direction as the first direction.

4. The display apparatus of claim 1, wherein the processor is configured to:
display the third object at a second location, at which the third object is moved by a specified distance in the second direction from a first location set to the third object; and
move the third object from the second location to the first location.

5. The display apparatus of claim 1, wherein the second object includes a selection menu and the third object includes a sub-menu of the second object.

6. The display apparatus of claim 1, wherein the second object includes a selection menu and the third object includes information about the second object.

7. The display apparatus of claim 1, wherein the second object includes a content selection menu and the third object includes a content image corresponding to the second object.

8. The display apparatus of claim 1, wherein the processor is configured to when moving the third object, change transparency of the third object.

9. The display apparatus of claim 8, wherein the processor is configured to gradually decrease the transparency of the third object.

10. The display apparatus of claim 1, wherein the processor is configured to:
when receiving the user input to select the second object, change a size of the second object during a specified time; and
move the third object during the specified time.

11. A controlling method of a display apparatus, the method comprising:
displaying a UI including a first object and a second object on a display;
receiving a user input to select the second object when the first object is selected as a currently selected object;
selecting the second object as the currently selected object based on the received user input in a first direction facing the second object from the first object;
displaying a third object corresponding to the selected second object on the display; and
moving the third object in a second direction based on the first direction.

12. The method of claim 11, wherein the second direction is a direction opposite to the first direction.

13. The method of claim 11, wherein the second direction is the same direction as the first direction.

14. The method of claim 11, wherein the moving of the third object in the second direction includes:
displaying the third object at a second location, at which the third object is moved by a specified distance in the second direction from a first location set to the third object; and
moving the third object from the second location to the first location.

15. The method of claim 11, wherein the second object includes a selection menu and the third object includes a sub-menu of the second object.

16. The method of claim 11, wherein the second object includes a selection menu and the third object includes information about the second object.

17. The method of claim 11, wherein the second object includes a content selection menu and the third object includes a content image corresponding to the second object.

18. The method of claim 11, wherein the moving of the third object includes when moving the third object, changing transparency of the third object.

19. The method of claim 18, wherein the changing of the transparency of the third object includes
gradually decreasing the transparency of the third object.

20. The method of claim 11, further comprising:
when receiving the user input to select the second object, changing a size of the second object during a specified time; and
wherein the moving of the third object includes:
moving the third object during the specified time.
